(19) United States
(12) Patent Application Publication
(10) Pub. No.: US 2008/0291801 A1
(43) Pub. Date: Nov. 27, 2008

(54) Record Carrier with Copy Protection Means

(75) Inventors: Antonius Adriaan Maria Staring, Eindhoven (NL); Johan Cornelis Talstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/095,136

(22) PCT Filed: Oct. 6, 2006
(86) PCT No.: PCT/IB2006/053664

§ 371 Date: May 28, 2008

(30) Foreign Application Priority Data
Nov. 29, 2005 (EP) 05111456.9

(51) Int. Cl. G11B 5/58

(52) U.S. Cl. 369/53.21

(57) ABSTRACT

In summary, ROM marks (such as wobbles, lateral deviations in the spiral with lands and pits in an optical disc) are used on optical media to ensure consumer-grade copying devices cannot duplicate original media. An additional level of security is that the detection of the side channel information requires knowledge of a certain secret, which must be hidden well in authorized players. If the secret leaks, a professional pirate will be able to detect the ROM mark and duplicate the original medium with the side channel information intact. The present invention proposes that instead of a single ROM mark, many ROM marks are applied to a disc. Further, devices are divided into groups, and each group has the capability to only detect one mark from the group. This way, if a secret is obtained from a device, the disc can be duplicated, but only a limited number of devices will be able to use this disc. Creating a disc that can be played in any device requires the hacking of one device from every group.

### FIELD OF THE INVENTION

The invention relates to a system, comprising a record carrier and players, wherein measures are in place for preventing illicit copy of copy-protected material present on the record carrier.

### BACKGROUND OF THE INVENTION

Record carriers, such as optical discs have become the preferred media for distribution of audio-visual entertainment content. The success story began with the introduction of the Compact Disc (CD) in the early 1980s. Whereas the CD was initially designed for playback of audio in consumer devices, it was quickly enhanced for computer use as well. The result was the CD-ROM format, which still is the most popular publishing format for computer data such as application and games software. In the early 1990s, when efficient video codecs became available, first the Video CD (VCD) and later the improved Super Video CD (SVCD) formats were added to the CD family. Digital Versatile Discs (DVD), introduced around the mid 1990s, have been broadly accepted. A DVD has a storage capacity that is around seven times larger than that of a CD, which is large enough to accommodate the DVD-Video format with its superior user experience, as compared to VHS tapes and [S]VCD. The intended successor of DVD, i.e. the Blu-ray disc (BD), will offer an even larger storage capacity, by a factor of six, an enhanced video quality, and extensive user interaction features.

The dark side to this success story is the phenomenon of large-scale professional piracy and widespread home copying of published discs. There are several driving factors behind these phenomena, where the most important one probably is the immense popularity of optical discs. With respect to professional piracy, another major factor is that mass production of optical discs is very cheap, while production equipment is readily available. In addition, legal action against counterfeit products is not high on the government's priority list in some parts of the world. With respect to home copying, an additional driving factor is the availability of cheap recordable media such as CD-R, DVD+R, etc., in combination with the capabilities of modern PCs and the convenience of the Internet.

This has made evident the need for copy-protection measures to be applied to optical discs. There is a variety of approaches to copy-protection; according to one of these approaches the disc is provided with an additional feature, the so-called “ROM mark”, which when a copy is made with consumer equipment, e.g. a CD-R/W drive, is not passed to the copy.

Some examples of ROM marks known in the art, in particular in relation to optical discs such as CDs, DVDs and BDs, are variations in the radial position, width or height of the track, in the density of data present along the track, in special patterns of correctable errors, in which case such ROM mark, is also known as side channel or hidden channel; this is described for example in EP 0930614 B1. Other examples of ROM marks known in the art are holograms, stamped patterns, and barcodes in the BCA.

According to this approach, an original disc can easily be distinguished from a copy, and access to the content information can be granted simply upon the detection of the ROM mark, or upon extraction of some kind of information from said ROM mark which is essential to allow access to the content information, e.g. a decryption key.

This type of approach is very effective in preventing normal users from making copies of prerecorded discs, and it puts a serious burden on professional pirates who want to produce pirated discs because such professional pirates need first of all to understand how the ROM mark is stored and then devise a method to replicate it, which requires a considerable amount of time and effort. However, once the pirates succeed in reproducing discs with the ROM mark, the entire copy protection system is severely compromised, and there is no way to recover and install new hurdles for the pirates.

### SUMMARY OF THE INVENTION

It is an object of the present invention to introduce a system comprising a record carrier and a plurality of player apparatuses for accessing the record carrier based on the presence of a ROM mark on the record carrier, whereby should a method to replicate a ROM mark become available, the impact on the entire copy protection system relied upon is less severe.

This object is achieved by a system as claimed in claim 1. The plurality of player apparatuses thereby comprises groups of player apparatuses differentiated one from another according to the detector they are provided with. Each player allows access to the content material upon detection of the ROM mark corresponding to the detector it is provided with. Once professional pirates should manage to replicate a ROM mark, pirated discs would only be readable by the group of players having the corresponding detector, whereas for all other players, i.e. for most of the players, the pirated discs would still be unreadable.

The plurality of ROM marks may comprise:

ROM marks relying on a variations of different physical parameters,

ROM marks relying on a variation of the same physical parameter, but at different locations,

ROM mark relying on a variation of the same physical parameter, but where the same physical parameter is modulated according to different encoding rules, at the same or different locations, and/or

ROM mark relying on a variation of the same physical parameter, based on spread spectrum techniques, where each ROM mark uses a different spreading sequence, at the same or different locations.

In principle, in order to be detected each ROM mark needs a suitable ad-hoc detector, capable of reconstructing a signal from the relevant physical variations. However, the same detector may be used to detect several ROM marks, when these ROM marks rely on a variation of the same physical parameter either at different locations, or, based on spread spectrum techniques, each ROM mark using a different spreading sequence. In this case, such same detector may be enabled to detect only one individual ROM mark by means of either an adequate instruction or hard-coded information. In the following, when reference is made to multiple detectors, this shall be intended to include the case of the same type of detectors, but adapted to detect different ROM marks.

Player apparatuses will normally be provided with one type of detector only. However they may also be provided with more than one detector, for example to increase robustness, i.e. the capability to access the content even if detection of one particular ROM mark fails, not due to the absence of the ROM mark but for example due to deterioration of the same, however the number of detectors present on a same player apparatus should definitely be small compared to the total number of ROM marks.

In the players, the access to the content information may be granted simply upon detection of the corresponding ROM mark: in this case the ROM marks are not required to carry any particular information or payload, and the decision to allow access is simply based on the presence or absence of the corresponding ROM mark. The main consequence is that the player needs to be compliant. In this case preferably the technique used to store the ROM mark is kept secret and measures are put in place to prevent tampering of the functionalities of the player. As an alternative, the access to the content information may be granted upon extraction of some information from said ROM mark which is essential to allow access to the content information, e.g. a decryption key. This provides a stronger protection system, since in this case there is no need to rely on compliance of the players. In this case however care is required so that the same information can be consistently extracted from a ROM mark.

Advantageously, the proposed solution can be combined with a broadcast encryption system, i.e. a key block, thereby providing a mechanism allowing revocation of player apparatuses by groups or individually. An important consequence is that in this way it is not required that all ROM marks present on a record carrier carry the same information or payload: in fact they may have each a different payload, which could then be used, in conjunction with the information present in the key block, to extract a common content decryption key.

Advantageous embodiments of the system according to the invention are claimed in the dependent claims.

The object is also achieved by a record carrier as claimed in claim 10 and by a player apparatus as claimed in claim 12.

### BRIEF DESCRIPTION OF THE DRAWINGS

These and other aspects of the system, record carrier and player apparatus according to the invention will be further elucidated and described with reference to the drawings. In the drawings:

FIG. 1 illustrates the basic principle of the invention,

FIGS. 2 to 6 show various embodiments of the system according to the invention, comprising a record carrier and a player,

FIG. 7 shows an embodiment specifically concerning a key hierarchy.

### DETAILED DESCRIPTION OF THE EMBODIMENTS

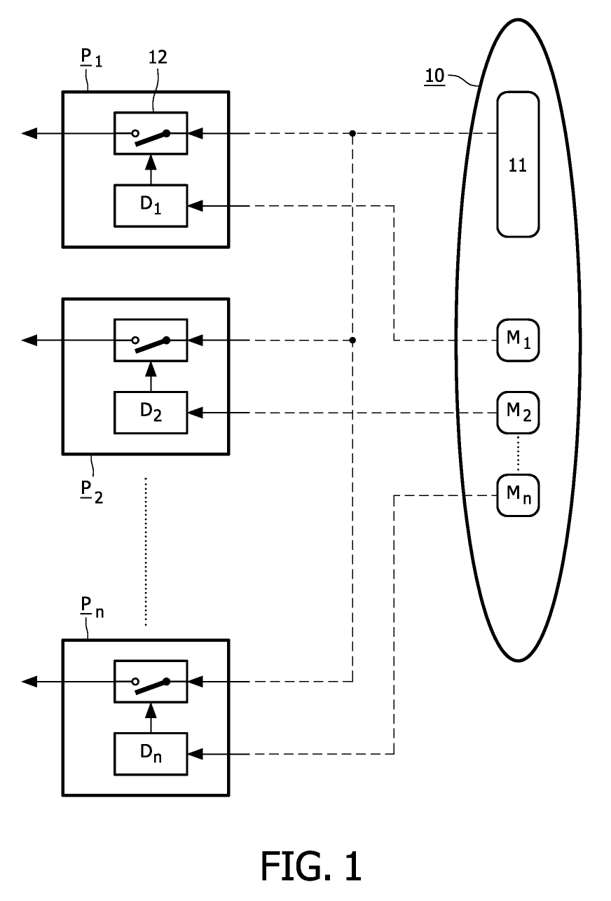

In FIG. 1, a record carrier 10 comprises content information 11 and a plurality of ROM marks M₁, M₂, . . . , Mₙ. This record carrier 10 can be accessed by a plurality of players, P₁, P₂, . . . , Pₙ, each representative of a respective larger group op players. Each of the players of the same group as P₁ comprises a detector D₁ capable of detecting only respective ROM marks M₁, each of the players of the same group as P₂ comprises a detector D₂ capable of detecting only respective ROM marks M₂, and so forth. Each of the players also comprises a control unit 12 designed to allow access to the content information 11 depending on if the respective detector has detected the respective ROM mark.

In the event that the professional pirates would become capable of controllably reproducing one of the marks, for example M₁, thereby producing illegal record carriers having the ROM mark M₁, these record carriers would be able to be played only by the players belonging to the same group as P₁, not by any other player, and this would result in frustration of the effort to produce illegal record carriers. Security of this system increases with the number of ROM marks, which should preferably be in the order of tens, hundreds or even thousands. Preferably it should be hidden to what group a player belongs, and players of the same group should be scattered among players of other groups, and not be concentrated for example in some particular geographical area.

In an embodiment the access to the content information 11 can be granted simply on the detection of the respective ROM mark, in which case the ROM mark does not need to carry any particular information or payload, and the control unit 12 is basically a switch allowing access to the content information 11 depending on whether the respective ROM mark has been detected by the respective detector or not.

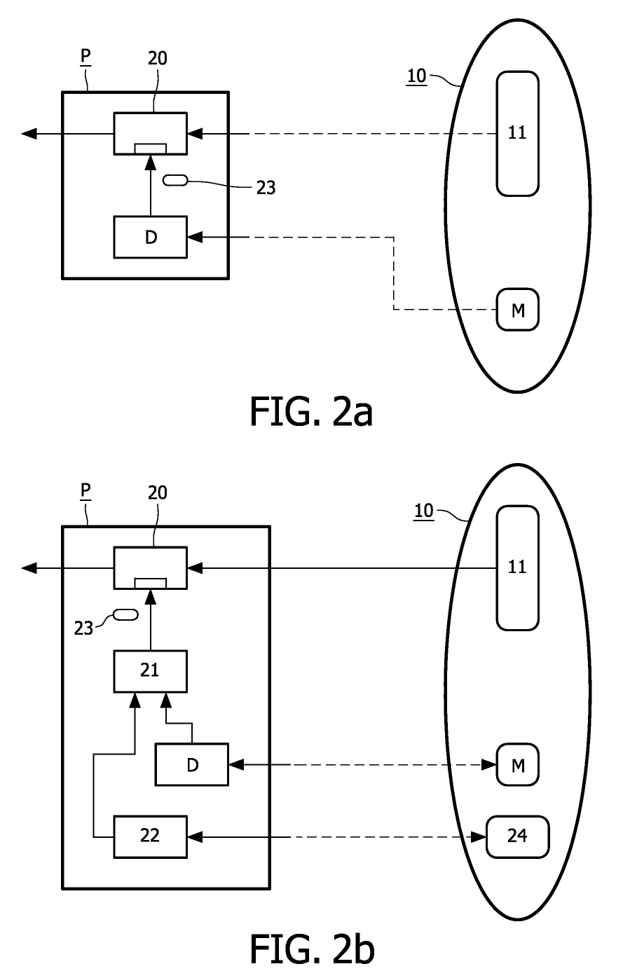

In an alternative embodiment, represented in FIG. 2a, the access to the content information 11 is possible upon extraction of some information from said ROM mark M which is essential to allow access to the content information 11, e.g. a content decryption key 23, in which case the control unit is a decryption unit 20.

A variation of this embodiment is shown in FIG. 2b, wherein, differently from FIG. 2a, the content decryption key 23 is not directly extracted from the ROM mark M, but reconstructed by a key reconstruction unit 21 on the basis of information extracted from the ROM mark M and of auxiliary information 24 retrieved from the record carrier 10 by a suitable auxiliary information retrieval unit 22. This embodiment is preferable to the one shown in FIG. 2a, because it does not require that all ROM marks carry the same payload, which fact would represent both a complication during production and a weakness from the security point of view.

The key reconstruction unit 21 may be another decryption block wherein, an encrypted version of the content decryption key is decrypted using a suitable decryption key, the encrypted version of the content decryption key being present in the auxiliary information 24 and the suitable decryption key being extractable from the ROM mark, or vice versa. In general the auxiliary information 24 may contain as many encrypted versions of the content decryption key or suitable decryption keys as there are ROM marks, in which case the auxiliary information 24 will be hereinafter referred as key block.

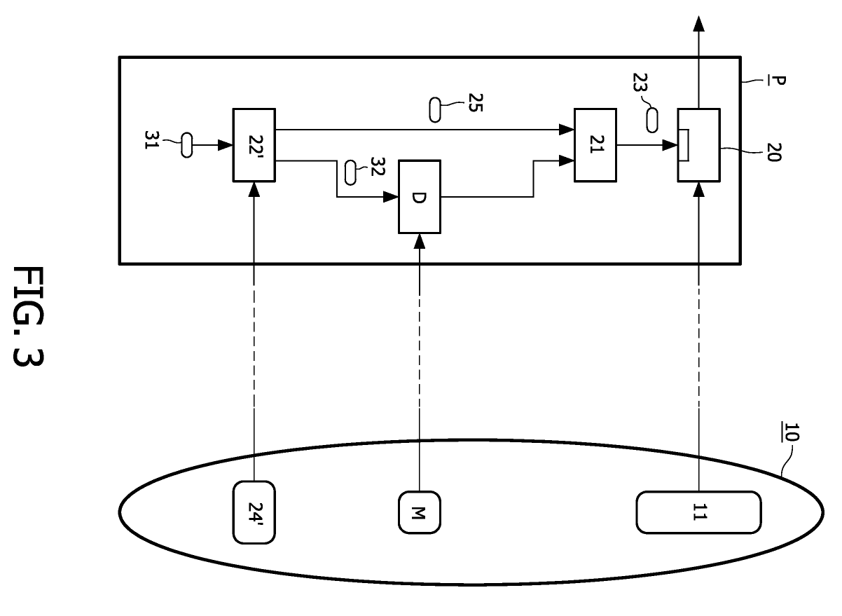

FIG. 3 shows a further embodiment of the system according to the invention. In this embodiment the auxiliary information is specifically represented by a key block 24′, and the auxiliary information retrieval unit is specifically represented by a key block processing unit 22′, which retrieves and processes the key block 24′, selects from the key block 24 that information which is relevant for the player P, hereinafter called key reconstruction information 25, and passes it to the key reconstruction unit 21 in order to allow reconstruction of the content decryption key 23.

In this embodiment, the key block processing unit 22′ operates also in dependence of a device ID and/or device keys 31 stored in the player P. As is common in broadcast encryption, some of these devices keys may be shared with other devices. The group ID 32 uniquely defines a group of devices to which a particular player P belongs and indicates which ROM mark contained on the record carrier 10 the player P must proceed to read.

It has been said that the set of ROM marks may comprise or even entirely consist of ROM marks relying on a variation of the same physical parameter, but for example residing at different locations, e.g. several ROM marks stored in the form of pit-wobble, at different positions along the track. In this case a same detector, i.e. a common detection unit, will be able to detect any of these ROM marks, once it is adequately informed on which group the player belongs to. For this reason, it is shown in FIG. 3 that the key block processing unit 22′ provides to the detector D the group ID 32 information.

The group ID 32 may be the same as or a part of the device ID. As an alternative though, the group ID 32 may also be yielded by the processing of the key block 24′. This opens up the possibility to assign players to the different ROM Marks dynamically, i.e. a given player or group of players may correspond to a first ROM mark in respect of a first record carrier, whereas it may correspond to a second ROM mark in respect of a second record carrier.

Although in FIG. 3 it is shown that the key block processing unit 22′ provides information directly to the key reconstruction unit 21, it shall be appreciated that in a variation of this embodiment, the key block processing unit 22′ may provide only the group ID 32 to the detector D.

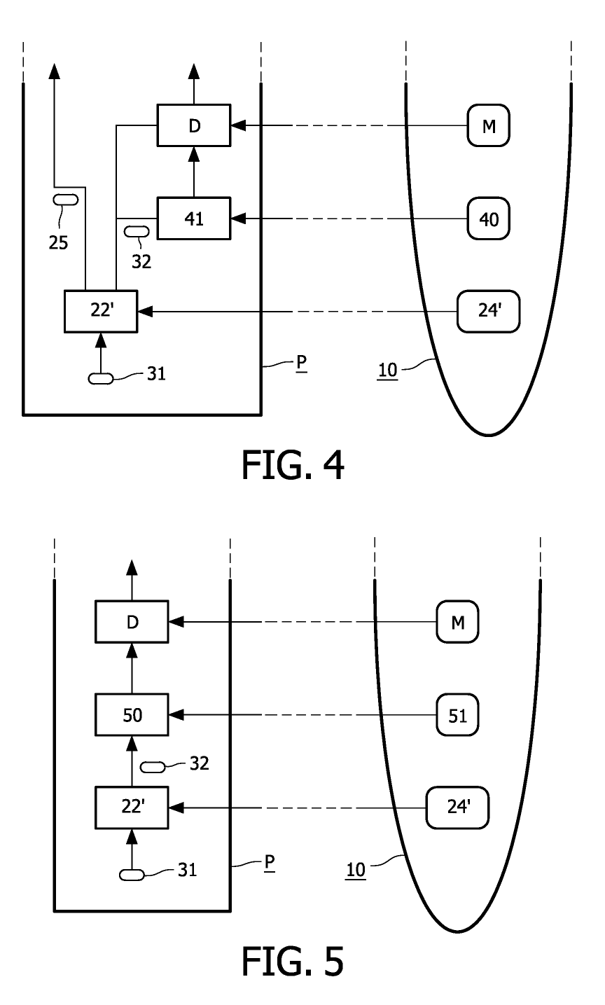

Such a system can be further enhanced in various ways. The ROM mark M could be placed at a range of positions on the record carrier 10, and the record carrier may further comprise position information 40, sometimes referred to as “salt”, to instruct the ROM mark detector D on the position where to look for the ROM mark M. This situation is depicted in FIG. 4, where a ROM mark location unit 41 determines, based on the group ID 32 and the position information 40 the location on the record carrier 10 at which the detector D has to look for the ROM mark M. Basically the salt is used to change the position of a group's ROM mark on the record carrier in the case different record carriers use a key block with the same groups. The salt may be a simple, single number, a look-up table, or an even more complex data structure. The ROM mark location unit 41 may comprise a hash function, or a more complex function, and its output may be the starting address on the disc where ROM mark detection should commence. Note that with this mechanism the salt guarantees that generally, when averaged over many titles, all devices have to spend an equal amount of time on jumps to the appropriate ROM mark. In addition, note that the number of groups in the key block may be larger than the number of ROM marks on the record carrier.

It has been said that the set of ROM marks may comprise or even entirely consist of ROM marks relying on a variation of the same physical parameter, but stored on the basis of different spreading sequences. Like in the case of ROM marks relying on a variation of the same physical parameter, but stored at different positions, also in this case a same detector will be able to detect any of these ROM marks, once it is adequately informed on the spreading sequence associated to a given ROM mark. It shall be understood that the common detection unit may be implemented in all or in part as a software routine, receiving as an input a given position or spreading sequence. The spreading sequence may be recorded on the record carrier, either in full or in compress form, e.g. as a key for seeding a pseudo random number generator. In particular it might be present in the key block, in which case it might be extracted and passed to the detector D by the key block processing unit 22′. In this way the ROM mark detector can only detect the ROM mark that is addressed to the device, and none of the other ROM marks. Moreover, the ROM mark detector cannot detect any ROM mark if the player has been revoked.

FIG. 5 shows a further embodiment of the system according to the invention. In addition to what is already shown in FIG. 3, a “seed” 51 is present on the record carrier 10. The seed 51 may be used to randomize the group ID 32 prior to passing it to the detector D. This is advantageous in case the key block 24′ on different record carriers 10 is identical, so that the key block processing unit 22′ yields the same set of group IDs 32 over and over again. The use of different seeds 51 on different record carriers ensures that the same detector D uses different spreading sequences on different record carriers 10. Note that this is different from the use of a salt 40, which only changes the position of the ROM mark M.

Numerous improvements and variations are possible in respect with the embodiments presented in FIGS. 3, 4 and 5.

In a first variation, the key block processing unit 22′ may yield two outputs: the key reconstruction information 25 to be passed to the key reconstruction unit 21, and an additional key reconstruction information to be passed to the ROM mark detector D. In systems where the plurality of ROM marks comprises or consists of ROM mark relying on a variation of the same physical parameter, based on spread spectrum techniques, where each ROM mark uses a different spreading sequence, the additional key reconstruction information might comprise in particular the spreading sequence by means of which the relevant ROM mark M can be detected. The key block 24′ may contain special data structures for this purpose.

In a second variation, an encrypted version of the content decryption key 23 may be stored in part in the key block 24′ and in part in the ROM mark M.

In a third variation, the record carrier 10 may also comprises a public key signature of the key block 24′ and the player would check this signature in order to avoid forged key blocks. Otherwise, it would suffice for pirates to reverse engineer only a few devices, and construct key blocks that contain only a small number of groups.

In a fourth variation, the record carrier may also comprise a digital signature of the content material. The digital signatures of the content material 11 and of the key block 24′ may be combined in a single signature.

In yet another variation, the seed 51 may be based on hashes of the encrypted content material 11, and those content hashes may be digitally signed. The reason for including content hashes into the key hierarchy is to make sure that licensed disc mastering facilities cannot abuse their equipment for legitimate discs using a copy protection system based on the techniques disclosed in this document to also author illicit content (e.g. ripped from DVD). If a disc mastering facility were to do this anyway, the signature verification or key generation step would produce incorrect results.

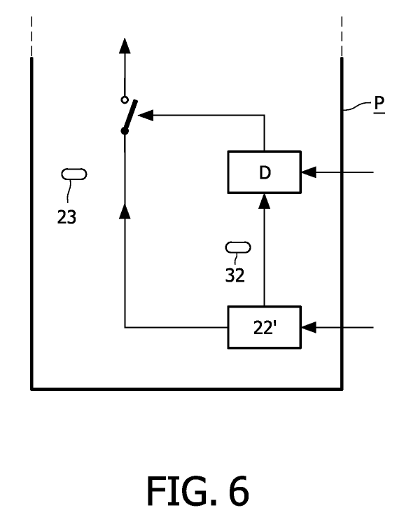

A further embodiment of the system according to the invention, reflecting an approach alternative to the one explained with reference to FIG. 3, is shown in FIG. 6. In contrast with the embodiment shown in FIG. 3 the ROM mark M does not contain any payload, i.e. the only thing that matters is whether it is present on the disc or not. In this case, the key block processing unit 22′ directly produces the content decryption key 23. The ROM mark detector D determines whether or not to pass the content decryption key 23 to the decryption unit 20, if the ROM mark is detected. An advantage of this embodiment is that a payload-less ROM mark may be significantly smaller than a payload-carrying variant. This means that the disc can accommodate more ROM marks, which can be read-out more quickly as well. In addition, a larger number of ROM marks on the disc means a higher security level. A disadvantage is that decision based systems might be easier to hack than information based systems, unless extra safeguards are in place to prevent tampering of the player apparatus.

The embodiment of FIG. 6 can be combined the various improvements and variations already described with reference to FIG. 3 to 5, like for example the already described check on a public key signature of the content material and/or key block 24′.

The presence of a key block in the record carrier 10 provides various advantages, in particular the possibility to revoke either groups or players or even individual players. To do this, it is sufficient for the content distributor not to include in the key block the information, e.g. decryption keys, relevant to the revoked groups or devices.

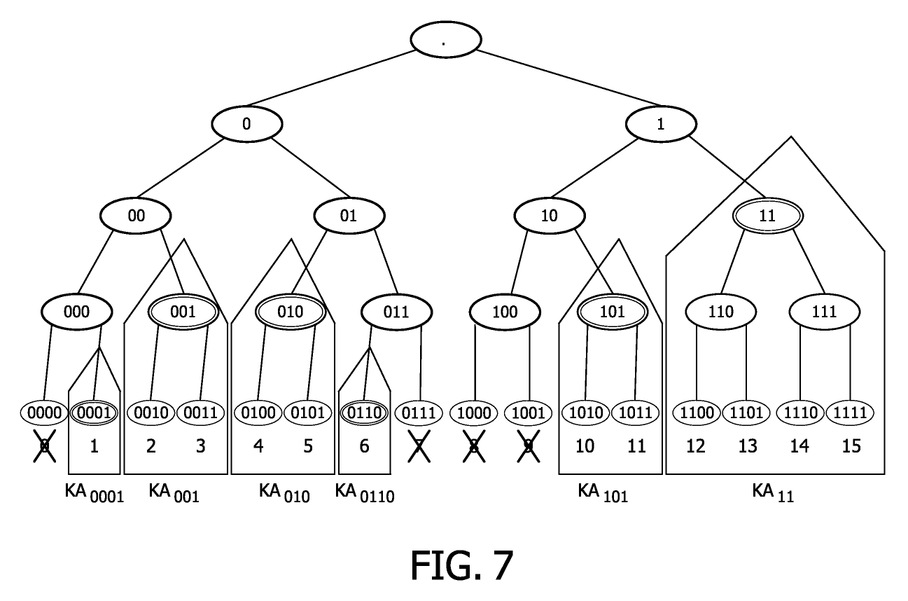

The key block could be based for example on the VCPS technology 0. As a background information, the main features of a VCPS key block are herewith explained with reference to FIG. 7. In the binary tree depicted in FIG. 7, devices are represented by the leaves. A cryptographic key, also known as a node key, is assigned to each of the nodes of this tree. Every device contains all node keys on the path from its leaf to the root of the tree. Each node key is shared by the group of devices contained in the subtree rooted at that particular node. A VCPS of key block consists of the same message, e.g. the content encryption key, encrypted multiple times with different node keys: {E_{Knode}_{_{—}}₁[K], . . . , E_{Knode}_{_{—}}ₙ[K]}. The set of node keys K_{node}_{_{—}}₁, . . . , K_{node}_{_{—}}ₙ determines which devices can get hold of K and which are excluded (revoked). The object KAᵢ=E_{Knode}_{_{—}}ᵢ[K] is called an authorization key. Within a VCPS key block, the set of nodes used {node₁, . . . , nodeₙ} is referred to as the tag part, whereas the collection of authorization keys {KA₁, . . . , KAₙ} is referred to as the key part.

In this case the content decryption key 23 is referred to as “root key” and the decryption key reconstruction information is referred to as “sub-root key”.

In an advantageous embodiment, the VCPS key block is modified as follows: the authorization keys as defined in 0 do not decrypt to a single root key. Instead, each authorization key decrypts to a sub-root key, where different groups in the key block may yield different sub-root keys, i.e., the key part has the form {E_{Knode}_{_{—}}₁[K₁], . . . , E_{Knode}_{_{—}}ₙ[Kₘ]}.

The different sub-root keys K₁, . . . , Kₘ can then be used to detect m different ROM-marks.

In summary, ROM marks (such as wobbles, lateral deviations in the spiral with lands and pits in an optical disc) are used on optical media to ensure consumer-grade copying devices cannot duplicate original media. An additional level of security is that the detection of the side channel information requires knowledge of a certain secret, which must be hidden well in authorized players.

If the secret leaks, a professional pirate will be able to detect the ROM mark and duplicate the original medium with the side channel information intact.

The present invention proposes that instead of a single ROM mark, many ROM marks are applied to a disc. Further, devices are divided into groups, and each group has the capability to only detect one mark from the group. This way, if a secret is obtained from a device, the disc can be duplicated, but only a limited number of devices will be able to use this disc. Creating a disc that can be played in any device requires the hacking of one device from every group.

### REFERENCES

Video Content Protection System for the DVD+R/+RW Video Recording Format, version 1.34, available from http://www.licensing.philips.com/vcps.

1. System comprising a record carrier (10) and a plurality of player apparatuses (P1, P2, . . . , Pn) for accessing the record carrier, the record carrier comprising content material (11) and bearing a set of ROM marks (M1, M2, . . . , Mn), each of the set of ROM marks being detectable by means of a respective corresponding detector out of a set of corresponding detectors (D1, D2, . . . , Dn), any player (P) out of the plurality of player apparatuses having a detector (D) out the set of corresponding detectors, the player being designed for allowing access to the content material upon detection of the ROM mark (M) to which the detector (D) present in the player (P) respectively corresponds.

2. System as claimed in claim 1, wherein the set of ROM marks (M1, M2, . . . , Mn) rely on a variation of a same physical parameter.

3. System as claimed in claim 2, and the corresponding detectors (D1, D2, . . . , Dn) are formed as instances of a common detection unit, enabled, according to which of the corresponding detectors is to be implemented, to detect only the corresponding ROM mark (M).

4. System as claimed in claim 3, wherein the common detection unit has an input to receive enabling information, thereby being enabled to detect the corresponding ROM mark (M).

5. System as claimed in claim 1, wherein the content material (11) is encrypted and the player apparatus (P) comprises a decryption unit (20) for decrypting the content material based upon a content decryption key (23).

6. System as claimed in claim 5, wherein the content decryption key (23) is extractable from the ROM mark (M).

7. System as claimed in claim 5, wherein the content decryption key (23) is determinable upon auxiliary information (24) present in the record carrier (10).

8. System as claimed in claim 2, wherein the apparatuses comprise a content decryption key reconstruction unit (21) for determining the content decryption key (23) upon a combination of information extractable from the ROM mark (M) and auxiliary information (24) present in the record carrier (10).

9. System as claimed in claim 7, wherein the record carrier (10) further comprises a digital signature of the auxiliary information (24) and/or of the content material (11).

10. Record carrier (10) comprising content material (11) and bearing a set of ROM marks (M1, M2, . . . , Mn), each of the set of ROM marks being detectable by means of a corresponding detector (D1, D2, . . . , Dn).

11. Record carrier (10) as claimed in claim 10, wherein the set of ROM marks (M1, M2, . . . , Mn) rely on a variation of a same physical parameter.

12. Player apparatus (P) for accessing a record carrier (10) as claimed in claim 11, the player comprising a detector (D) for detecting a respective corresponding ROM mark (M) among the set of ROM marks (M1, M2, . . . , Mn), the detector being formed as a detection unit, enabled to detect only the ROM mark (M) to which it respectively corresponds.
